(19) United States
(12) Patent Application Publication
(10) Pub. No.: US 2025/0048184 A1
(43) Pub. Date: Feb. 6, 2025

(54) COMMUNICATION APPARATUS AND COMMUNICATION METHOD

(71) Applicant: KYOCERA Corporation, Kyoto (JP)

(72) Inventors: Masato FUJISHIRO, Yokohama-shi (JP); Mitsutaka HATA, Yokohama-shi (JP)

(73) Assignee: KYOCERA Corporation, Kyoto (JP)

(21) Appl. No.: 18/920,410

(22) Filed: Oct. 18, 2024

Related U.S. Application Data
(63) Continuation of application No. PCT/JP2023/015484, filed on Apr. 18, 2023.

(30) Foreign Application Priority Data
Apr. 19, 2022 (JP) 2022-069111

(51) Int. Cl. H04W 28/16; G06N 3/02; H04W 28/02

(52) U.S. Cl. CPC H04W 28/16; H04W 28/0215; G06N 3/02

(57) ABSTRACT

A communication apparatus configured to communicate with a communication apparatus in a mobile communication system using a machine learning technology includes a controller configured to perform machine learning processing of learning processing to derive a learned model by using learning data and/or inference processing to infer inference result data from inference data by using the learned model, and a transmitter configured to transmit, to the communication apparatus, a message including an information element related to a processing capacity and/or a storage capacity usable by the communication apparatus for the machine learning processing.

### RELATED APPLICATIONS

The present application is a continuation based on PCT Application No. PCT/JP2023/015484, filed on Apr. 18, 2023, which claims the benefit of Japanese Patent Application No. 2022-069111 filed on Apr. 19, 2022. The content of which is incorporated by reference herein in their entirety.

### TECHNICAL FIELD

The present disclosure relates to a communication apparatus and a communication method used in a mobile communication system.

### BACKGROUND

In recent years, in the Third Generation Partnership Project (3GPP) (trade name, the same shall apply hereinafter), which is a standardization project for mobile communication systems, a study has been underway to apply an artificial intelligence (AI) technology, particularly, a machine learning (IL) technology to wireless communication (air interface) in the mobile communication system.

### CITATION LIST

### Non-Patent Literature

Non-Patent Document 1: 3GPP Contribution RP-213599, “New SI. Study on Artificial Intelligence (AI)/Machine Learning (ML) for NR Air Interface”

### SUMMARY

In a first aspect, a communication apparatus is an apparatus configured to communicate with another communication apparatus different from the communication apparatus in a mobile communication system using a machine learning technology. The communication apparatus includes a controller configured to perform machine learning processing of learning processing to derive a learned model by using learning data and/or inference processing to infer inference result data from inference data by using the learned model, and a transmitter configured to transmit, to the other communication apparatus, a message including an information element related to a processing capacity and/or a storage capacity usable by the communication apparatus for the machine learning processing.

In a second aspect, a communication method is a method performed by a communication apparatus configured to communicate with another communication apparatus different from the communication apparatus in a mobile communication system using a machine learning technology. The communication method includes performing machine learning processing of learning processing to derive a learned model by using learning data and/or inference processing to infer inference result data from inference data by using the learned model, and transmitting, to the other communication apparatus, a message including an information element related to a processing capacity and/or a storage capacity usable by the communication apparatus for the machine learning processing.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a functional block configuration of an AI/ML technology in the mobile communication system according to the embodiment.

FIG. 7 is a diagram illustrating an overview of operations relating to each operation scenario according to an embodiment.

FIG. 8 is a diagram illustrating a first operation scenario according to an embodiment.

FIG. 9 is a diagram illustrating a first example of reducing CSI-RSs according to an embodiment.

FIG. 10 is a diagram illustrating a second example of reducing the CSI-RSs according to an embodiment.

FIG. 11 is an operation flow diagram illustrating a first operation example relating to a first operation scenario according to an embodiment.

FIG. 12 s an operation flow diagram illustrating a second operation example relating to the first operation scenario according to an embodiment.

FIG. 13 is an operation flow diagram illustrating a third operation example relating to the first operation scenario according to an embodiment.

FIG. 14 is a diagram illustrating a second operation scenario according to an embodiment.

FIG. 15 is an operation flow diagram illustrating an operation example relating to the second operation scenario according to an embodiment.

FIG. 16 is a diagram illustrating a third operation scenario according to an embodiment.

FIG. 17 is an operation flow diagram illustrating an operation example relating to the third operation scenario according to an embodiment.

FIG. 18 is a diagram for illustrating capability information or load status information according to an embodiment.

FIG. 19 is a diagram for illustrating a configuration of a model according to an embodiment.

FIG. 20 is a diagram illustrating a first operation example for model transfer according to an embodiment.

FIG. 21 is a diagram illustrating an example of a configuration message including a model and additional information according to the embodiment.

FIG. 22 is a diagram illustrating a second operation example for the model transfer according to an embodiment.

FIG. 23 is a diagram illustrating an operation example for divided configuration message transmission according to an embodiment.

FIG. 24 is a diagram illustrating a third operation example for the model transfer according to an embodiment.

### DESCRIPTION OF EMBODIMENTS

For applying a machine learning technology to mobile communication system, a specific technique for leveraging machine learning processing has not yet been established.

In view of this, the present disclosure is to enable the machine learning processing to be leveraged in the mobile communication system.

A mobile communication system according to an embodiment is described with reference to the drawings. In the description of the drawings, the same or similar parts are denoted by the same or similar reference signs.

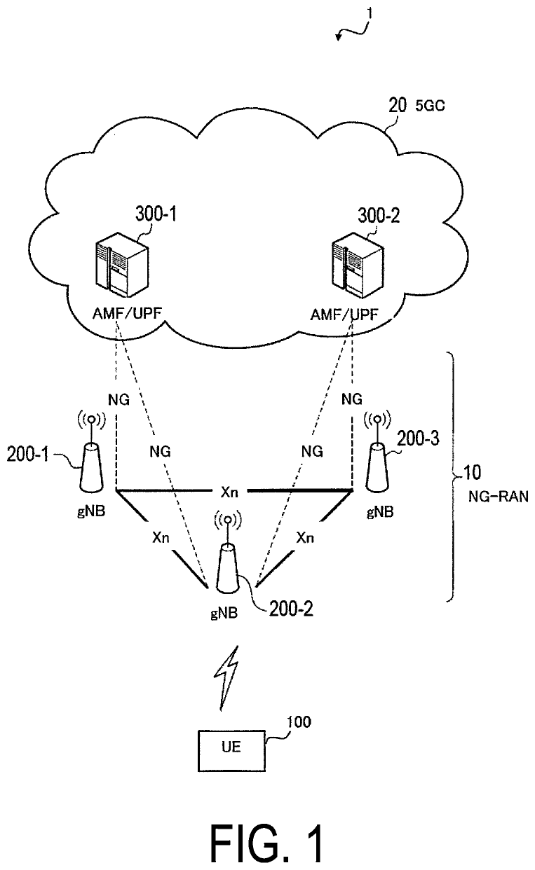

Configuration of Mobile Communication System First, a configuration of a mobile communication system according to an embodiment is described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

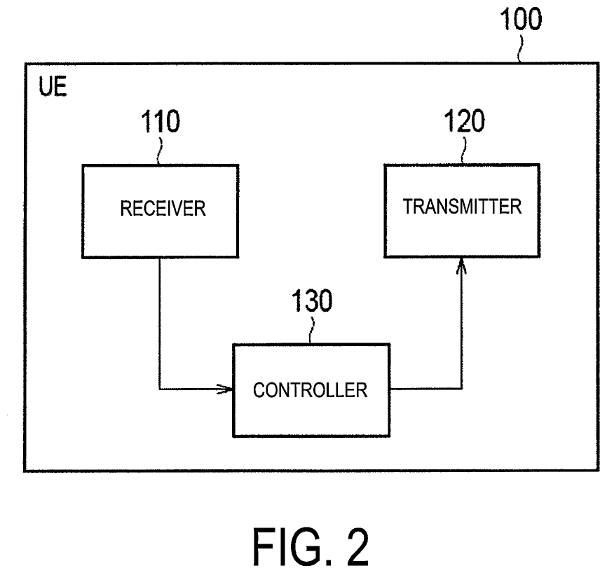

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

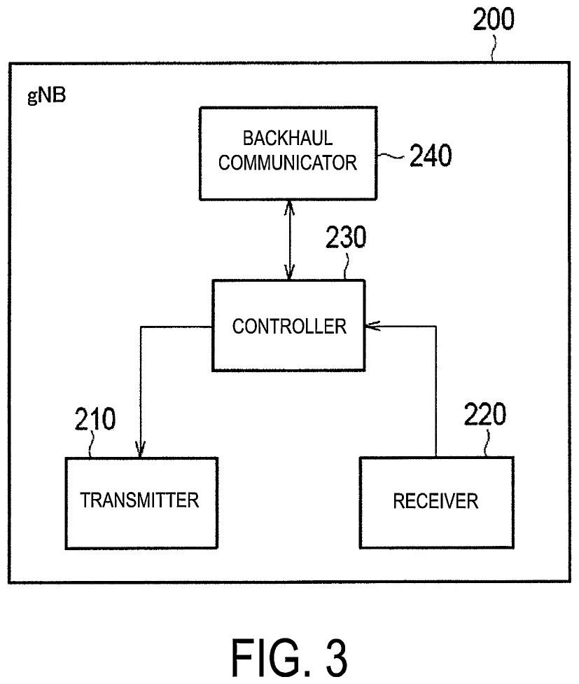

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a communicator that performs wireless communication with the UE 100. The backhaul communicator 240 constitutes a network communicator that performs communication with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a central unit (CU) and a distributed unit (DU) (i.e., functions are divided), and the two units may be connected via an F1 interface, which is a fronthaul interface.

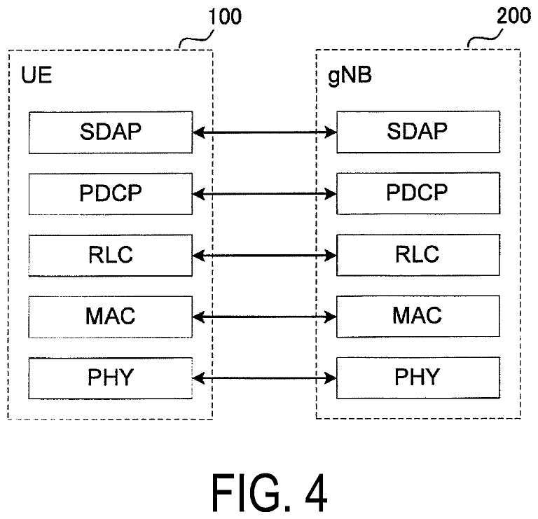

FIG. 4 is a diagram illustrating a configuration of a protocol stack of a radio interface of a user plane handling data.

A radio interface protocol of the user plane includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH).

Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

In the NR, the UE 100 may use a bandwidth that is narrower than a system bandwidth (i.e., a bandwidth of the cell). The gNB 200 configures a bandwidth part (BWP) consisting of consecutive PRBs for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by control in the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on the serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive OFDM symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an access stratum (AS). Note that, when the RAN is connected to the EPC, the SDAP need not be provided.

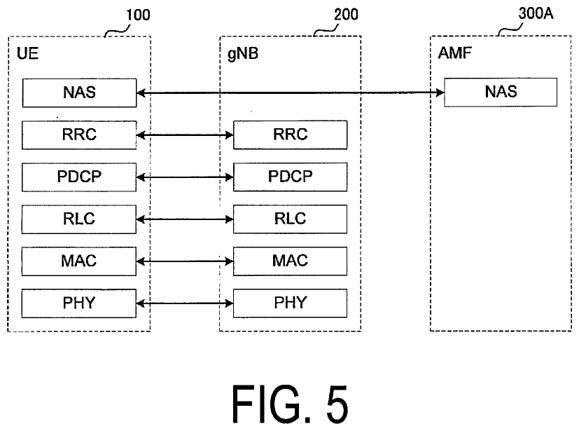

FIG. 5 is a diagram illustrating a configuration of a protocol stack of a radio interface of a control plane handling signaling (a control signal).

The protocol stack of the radio interface of the control plane includes a radio resource control (RRC) layer and a non-access stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

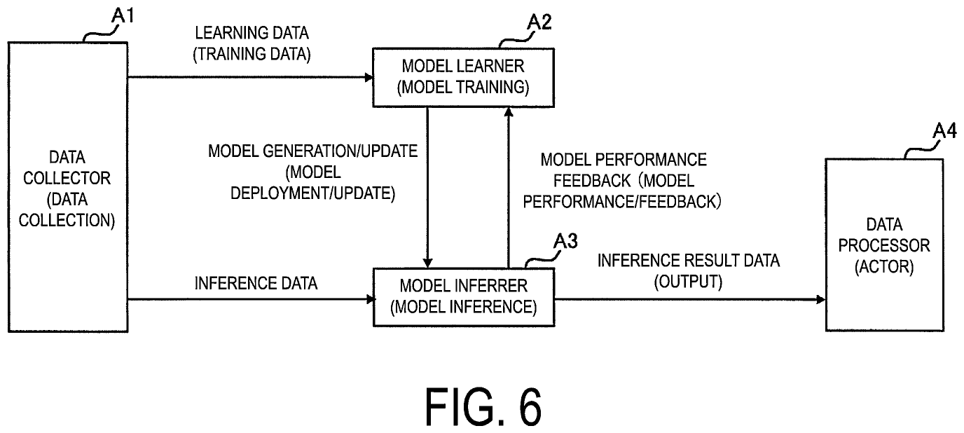

Overview of AI/ML Technology In the embodiment, an AI/ML Technology is described. FIG. 6 is a diagram illustrating a functional block configuration of the AI/ML technology in the mobile communication system 1 according to the embodiment.

The functional block configuration illustrated in FIG. 6 includes a data collector A1, a model learner A2, a model inferrer A3, and a data processor A4.

The data collector A1 collects input data, specifically, learning data and inference data, and outputs the learning data to the model learner A2 and outputs the inference data to the model inferrer A3. The data collector A1 may acquire, as the input data, data in an apparatus provided with the data collector A1 itself. The data collector A1 may acquire, as the input data, data in another apparatus.

The model learner A2 performs model learning. To be specific, the model learner A2 optimizes parameters for the learning model by machine learning using the learning data, derives (generates or updates) learned model, and outputs the learned model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the learning data. The unsupervised learning is a method of not using correct answer data for the learning data. For example, in the unsupervised learning, feature points are learned from a large amount of learning data, and correct answer determination (range estimation) is performed. The reinforcement learning is a method of assigning a score to an output result and learning a method of maximizing the score.

The model inferrer A3 performs model inference. To be specific, the model inferrer A3 infers an output from the inference data by using the learned model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a learned model. Here, various approaches for the model are used, such as linear regression analysis, neural network, and decision tree analysis. The above “y=ax+b” can be considered as one kind of the linear regression analysis. The model inferrer A3 may perform model performance feedback to the model learner A2.

The data processor A4 receives the inference result data and performs processing using the inference result data.

When a machine learning technology is applied to wireless communication in a mobile communication system, how to arrange the functional block configuration as illustrated in FIG. 6 is a problem. In the description of each embodiment, wireless communication between the UE 100 and the gNB 200 is mainly assumed. In this case, how to arrange the functional blocks of FIG. 6 in the UE 100 and the gNB 200 is a problem. After the arrangement of each of the functional blocks is determined, how to control and configure each of the functional blocks by the gNB 200 with respect to the UE 100 is a problem.

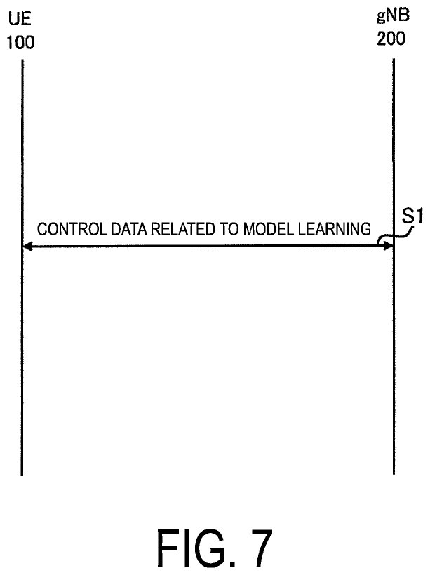

FIG. 7 is a diagram illustrating an overview of operations relating to each operation scenario according to an embodiment. In FIG. 7, one of the UE 100 and the gNB 200 corresponds to a first communication apparatus, and the other corresponds to a second communication apparatus.

In step S1, the UE 100 transmits or receives control data related to the model learning to or from the gNB 200. The control data may be an RRC message that is RRC layer (i.e., layer 3) signaling. The control data may be a MAC Control Element (CE) that is MAC layer (i.e., layer 2) signaling. The control data may be downlink control information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### First Operation Scenario

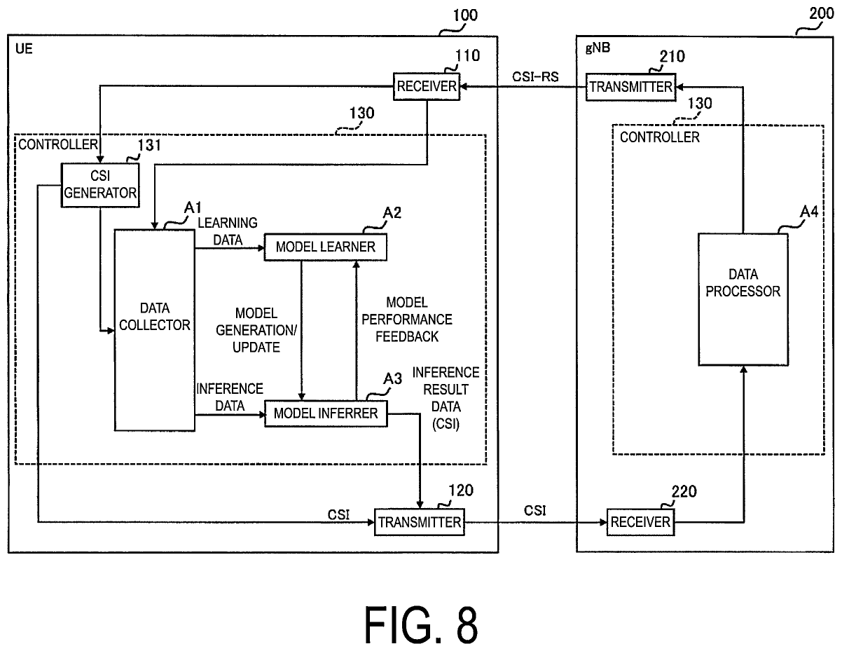

FIG. 8 is a diagram illustrating a first operation scenario according to an embodiment. In the first operation scenario, the data collector A1, the model learner A2, and the model inferrer A3 are arranged in the UE 100 (e.g., the controller 130), and the data processor A4 is arranged in the gNB 200 (e.g., the controller 230). In other words, model learning and model inference are performed on the UE 100 side.

In the first operation scenario, the machine learning technology is introduced into channel state information (CSI) feedback from the UE 100 to the gNB 200. The CSI transmitted (fed back) from the UE 100 to the gNB 200 is information indicating a downlink channel state between the UE 100 and the gNB 200. The CSI includes at least one selected from the group consisting of a channel quality indicator (CQI), a precoding matrix indicator (PMI), and a rank indicator (RI). The gNB 200 performs, for example, downlink scheduling based on the CSI feedback from the UE 100.

The gNB 200 transmits a reference signal for the UE 100 to estimate a downlink channel state. Such a reference signal may be, for example, a CSI reference signal (CSI-RS) or a demodulation reference signal (DMRS). In the description of the first operation scenario, assume that the reference signal is a CSI-RS.

First, in the model learning, the UE 100 (receiver 110) receives a first reference signal from the gNB 200 by using a first resource. Then, the UE 100 (model learner A2) derives a learned model for inferring CSI from the reference signal by using learning data including the first reference signal. In the description of the first operation scenario, such a first reference signal may be referred to as a full CSI-RS.

For example, the UE 100 (CSI generator 131) performs channel estimation by using the reception signal (CSI-RS) received by the receiver 110 from the gNB 200, and generates CSI. The UE 100 (transmitter 120) transmits the generated CSI to the gNB 200. The model learner A2 performs model learning by using a plurality of sets of the reception signal (CSI-RS) and the CSI as the learning data to derive a learned model for inferring the CSI from the reception signal (CSI-RS).

Second, in the model inference, the UE 100 (receiver 110) receives a second reference signal from the gNB 200 by using a second resource that is less than the first resource. Then, the UE 100 (model inferrer A3) uses the learned model to infer the CSI as the inference result data from inference data including the second reference signal. In the description of the first operation scenario, such a second reference signal may be referred to as a partial CSI-RS or a punctured CSI-RS.

For example, the UE 100 (model inferrer A3) uses the reception signal (CSI-RS) received by the receiver 110 from the gNB 200 as the inference data, and infers the CSI from the reception signal (CSI-RS) by using the learned model. The UE 100 (transmitter 120) transmits the inferred CSI to the gNB 200.

This enables the UE 100 to feed back accurate (complete) CSI to the gNB 200 from a small number of CSI-RSs (partial CSI-RSs) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

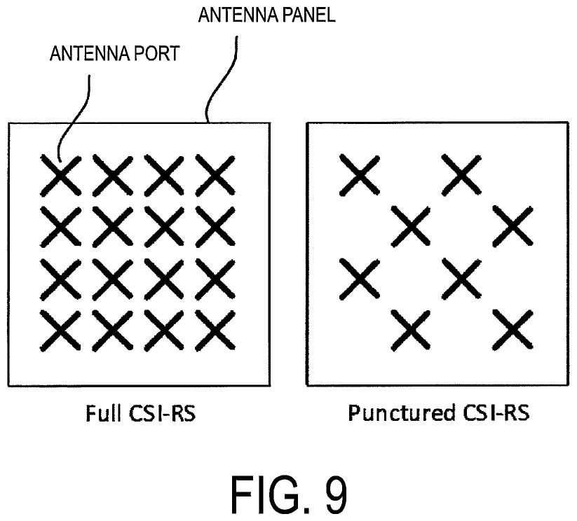

FIG. 9 is a diagram illustrating a first example of reducing CSI-RSs according to an embodiment. In the first example, the gNB 200 reduces the number of antenna ports for transmitting the CSI-RS. For example, the gNB 200 transmits the CSI-RS from all antenna ports of the antenna panel in a mode in which the UE 100 performs the model learning. On the other hand, in the mode in which the UE 100 performs model inference, the gNB 200 reduces the number of antenna ports for transmitting the CSI-RSs, and transmits the CSI-RSs from half the antenna ports of the antenna panel. Note that the antenna port is an example of the resource. This can reduce the overhead, improve a utilization efficiency of the antenna ports, and give an effect of power consumption reduction.

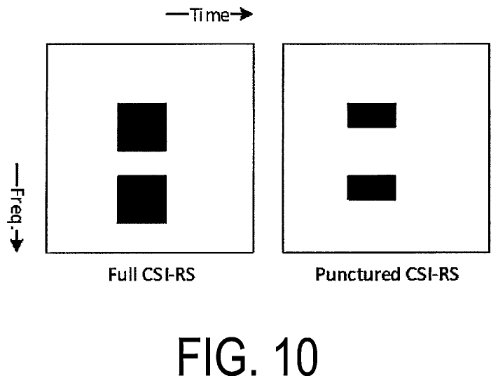

FIG. 10 is a diagram illustrating a second example of reducing the CSI-RSs according to an embodiment. In the second example, the gNB 200 reduces the number of radio resources for transmitting the CSI-RSs, specifically, the number of time-frequency resources. For example, the gNB 200 transmits the CSI-RS by using a predetermined time-frequency resource in a mode in which the ULE 100 performs the model learning. On the other hand, in a mode in which the UE 100 performs the model inference, the gNB 200 transmits the CSI-RS using a smaller amount of time-frequency resources than predetermined time-frequency resources. This can reduce the overhead, improve a utilization efficiency of the radio resources, and give an effect of power consumption reduction.

A first operation example relating to the first operation scenario is described. In the first operation example, the gNB 200 transmits a switching notification as the control data to the UE 100, the switching notification providing notification of mode switching between a mode for performing the model learning (hereinafter, also referred to as a “learning mode”) and a mode for performing model inference (hereinafter, also referred to as an “inference mode”). The UE 100 receives the switching notification and performs the mode switching between the learning mode and the inference mode. This enables the mode switching to be appropriately performed between the learning mode and the inference mode. The switching notification may be configuration information to configure a mode for the UE 100. The switching notification may also be a switching command for indicating to the UE 100 the mode switching.

In the first operation example, when the model learning is completed, the UE 100 transmits a completion notification as the control data to the gNB 200, the completion notification indicating that the model learning is completed. The gNB 200 receives the completion notification. This enables gNB 200 to grasp that the model learning is completed on the UE 100 side.

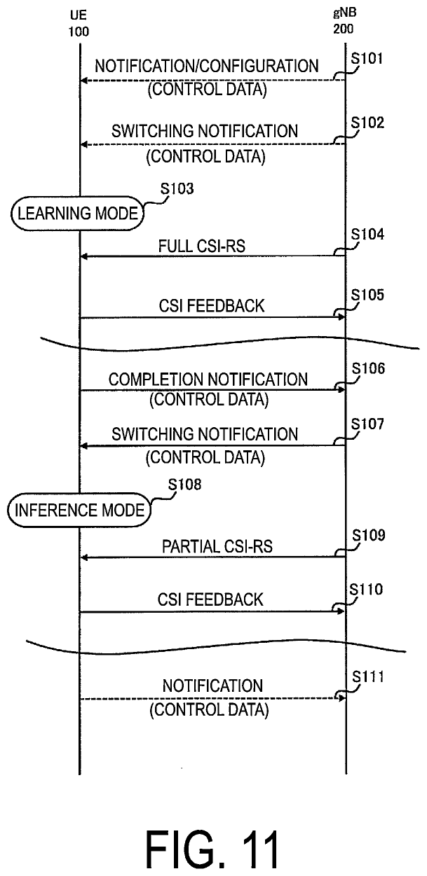

FIG. 11 is an operation flow diagram illustrating the first operation example relating to the first operation scenario according to an embodiment. This flow may be performed after the UE 100 establishes an RRC connection to the cell of the gNB 200. Note that in the operation flow described below, dashed lines indicate steps which may be omitted.

In step S101, the gNB 200 may notify the UE 100 of or configure for the UE, as the control data, an input data pattern in the inference mode, for example, a transmission pattern (puncture pattern) of the CSI-RS in the inference mode. For example, the gNB 200 notifies the UE 100 of the antenna port and/or the time-frequency resource for transmitting or not transmitting the CSI-RS in the inference mode.

In step S102, the gNB 200 may transmit a switching notification for starting the learning mode to the UE 100.

In step S103, the UE 100 starts the learning mode.

In step S104, the gNB 200 transmits a full CSI-RS. The UE 100 receives the full CSI-RS and generates CSI based on the received CSI-RS. In the learning mode, the UE 100 may perform supervised learning using the received CSI-RS and CSI corresponding to the received CSI-RS. The UE 100 may derive and manage a learning result (learned model) per communication environment of the UE 100, for example, per reception quality (RSRP, RSRQ, or SINR) and/or migration speed.

In step S105, the UE 100 transmits (feeds back) the generated CSI to the gNB 200.

Thereafter, in step S106, when the model learning is completed, the UE 100 transmits a completion notification indicating that the model learning is completed to the gNB 200. The UE 100 may transmit the completion notification to the gNB 200 when the derivation (generation or update) of the learned model is completed. Here, the UE 100 may transmit a notification indicating that learning is completed per communication environment (e.g., migration speed and reception quality) of the UE 100 itself. In this case, the UE 100 includes, in the notification, information indicating for which communication environment the completion notification is.

In step S107, the gNB 200 transmits, to the UE 100, a switching information notification for switching from the learning mode to the inference mode.

In step S108, the UE 100 switches from the learning mode to the inference mode in response to receiving the switching notification in step S107.

In step S109, the gNB 200 transmits a partial CSI-RS. Once receiving the partial CSI-RS, the UE 100 uses the learned model to infer CSI from the received CSI-RS. The UE 100 may select a learned model corresponding to the communication environment of the UE 100 itself from among learned models managed per communication environment, and may infer the CSI using the selected learned model.

In step S110, the UE 100 transmits (feeds back) the inferred CSI to the gNB 200.

In step S111, when the UE 100 determines that the model learning is necessary, the UE 100 may transmit a notification as the control data to the gNB 200, the notification indicating that the model learning is necessary. For example, the UE 100 considers that accuracy of the inference result cannot be guaranteed and transmits the notification to the gNB 200 when the UE 100 moves, the migration speed of the UE 100 changes, the reception quality of the UE 100 changes, the cell in which the UE exists changes, or the bandwidth part (BWP) the UE 100 uses for communication changes.

A second operation example relating to the first operation scenario is described. The second operation example may be used together with the above-described operation example. In the second operation example, the gNB 200 transmits a completion condition notification as the control data to the UE 100, the completion condition notification indicating a completion condition of the model learning. The UE 100 receives the completion condition notification and determines completion of the model learning based on the completion condition notification. This enables the UE 100 to appropriately determine the completion of the model learning. The completion condition notification may be configuration information to configure the completion condition of the model learning for the UE 100. The completion condition notification may be included in the switching notification providing notification of (indicating) switching to the learning mode.

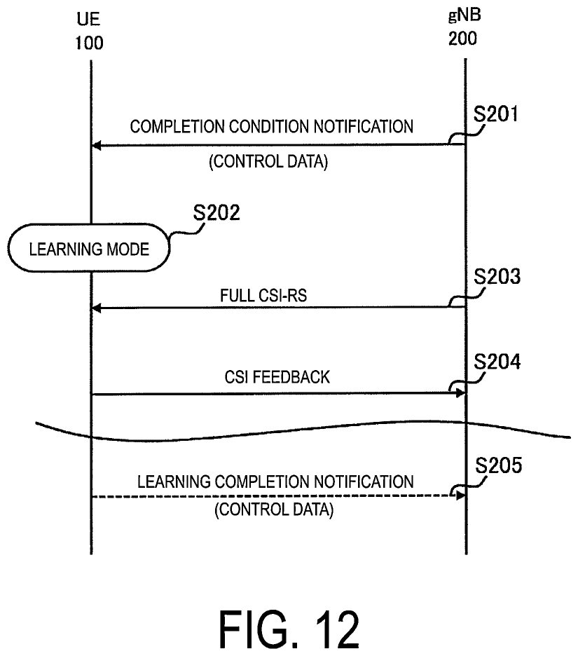

FIG. 12 s an operation flow diagram illustrating the second operation example relating to the first operation scenario according to an embodiment.

In step S201, the gNB 200 transmits the completion condition notification as the control data to the UE 100, the completion condition notification indicating the completion condition of the model learning. The completion condition notification may include at least one selected from the group consisting of the following pieces of completion condition information.

### Acceptable Error for Correct Answer Data:

For example, adopted is an acceptable range of an error between the CSI generated by using a normal CSI feedback calculation method and the CSI inferred by the model inference. At a stage where the learning has progressed to some extent, the UE 100 can infer the CSI by using the learned model at that point in time, compare the CSI with the correct CSI, and determine that the learning is completed based on that the error is within the acceptable range.
The number of pieces of learning data:
   The number of pieces of data used for learning. For example, the number of received CSI-RSs corresponds to the number of pieces of learning data. The UE 100 can determine that the learning is completed based on that the number of received CSI-RSs in the learning mode reaches the number of pieces of learning data indicated by a notification (configuration).

### The Number of Learning Trials:

The number of times the model learning is performed using the learning data. The UE 100 can determine that the learning is completed based on that the number of times of the learning in the learning mode reaches the number of times indicated by a notification (configuration).

### Output Score Threshold:

For example, a score in reinforcement learning. The UE 100 can determine that the learning is completed based on that the score reaches the score indicated by a notification (configuration).

The UE 100 continues the learning based on the full CSI-RS until determining that the learning is completed (step S203, S204).

In step S205, the UE 100, when determining that the model learning is completed, may transmit a completion notification indicating that the model learning is completed to the gNB 200.

A third operation example relating to the first operation scenario is described. The third operation example may be used together with the above-described operation examples. When the accuracy of the CSI feedback is desired to be increased, not only the CSI-RS but also other types of data, for example, reception characteristics of a physical downlink shared channel (PDSCH) can be used as the learning data and the inference data. In the third operation example, the gNB 200 transmits data type information as the control data to the UE 100, the data type information designating at least a type of data used as the learning data. In other words, the gNB 200 designates what is to be the learning data/inference data (type of input data) with respect to the UE 100. The UE 100 receives the data type information and performs the model learning using the data of the designated data type. This enables the UE 100 to perform appropriate model learning.

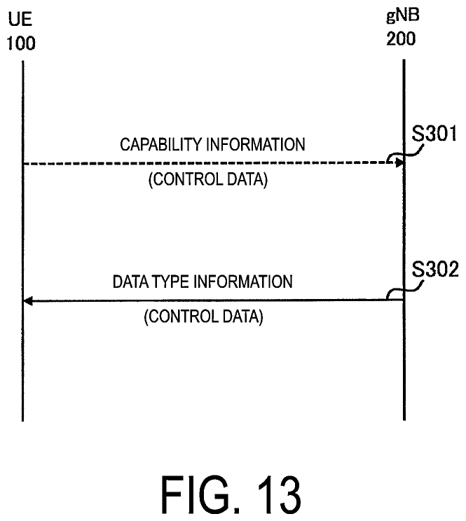

FIG. 13 is an operation flow diagram illustrating the third operation example relating to the first operation scenario according to an embodiment.

In step S301, the UE 100 may transmit capability information as the control data to the gNB 200, the capability information indicating which type of input data the UE 100 can handle in the machine learning. Here, the UE 100 may further transmit a notification indicating additional information such as the accuracy of the input data.

In step S302, the UE 100 transmits the data type information to the gNB 200. The data type information may be configuration information to configure a type of the input data for the UE 100. Here, the type of the input data may be the reception quality and/or UE migration speed for the CSI feedback. The reception quality may be reference signal received power (RSRP), reference signal received quality (RSRQ), signal-to-interference-plus-noise ratio (SINR), bit error rate (BER), block error rate (BLER), analog-to-digital converter output waveform, or the like.

Note that when UE positioning to be described below is assumed, the type of the input data may be position information (latitude, longitude, and altitude) of Global Navigation Satellite System (GNSS), RF fingerprint (cell ID, reception quality thereof, and the like), angle of arrival (AoA) of reception signal, reception level/reception phase/reception time difference (OTDOA) for each antenna, roundtrip time, and reception information of short-range wireless communication such as a wireless Local Area Network (LAN).

Note that the gNB 200 may designate the type of the input data independently for each of the learning data and the inference data. The gNB 200 may designate the type of input data independently for each of the CSI feedback and the UE positioning.

Second Operation Scenario A second operation scenario is described mainly on differences from the first operation scenario. The first operation scenario has mainly described the downlink reference signal (that is, downlink CSI estimation). The second operation scenario describes an uplink reference signal (that is, uplink CSI estimation). In the description of the second operation scenario, assume that the uplink reference signal is a sounding reference signal (SRS), but may be an uplink DMRS or the like.

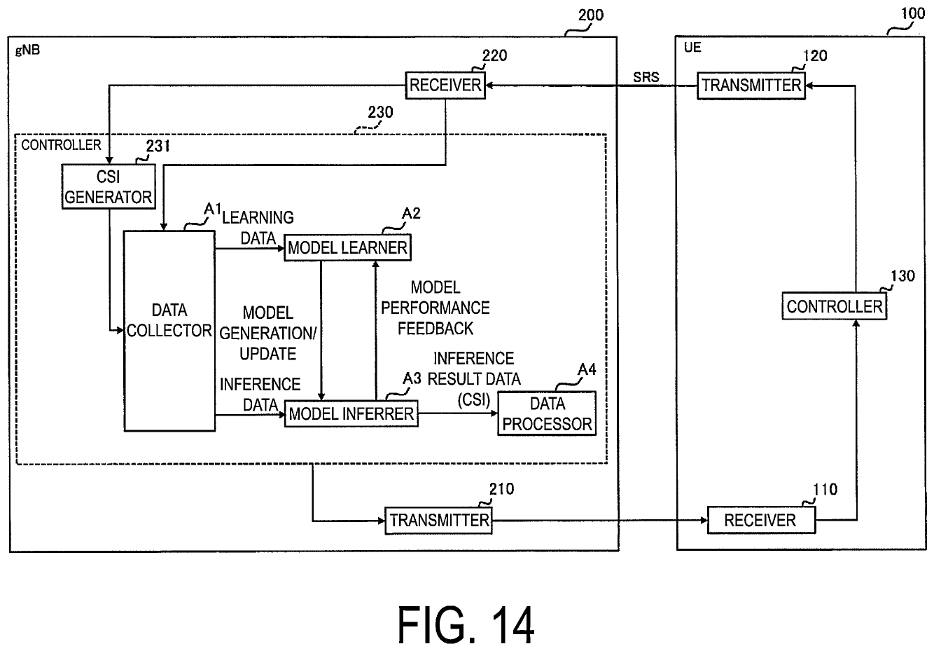

FIG. 14 is a diagram illustrating the second operation scenario according to an embodiment. In the second operation scenario, the data collector A1, the model learner A2, the model inferrer A3, and the data processor A4 are arranged in the gNB 200 (e.g., the controller 230). In other words, the model learning and the model inference are performed on the gNB 200 side.

In the second operation scenario, the machine learning technology is introduced into the CSI estimation performed by the gNB 200 based on the SRS from the UE 100. Therefore, the gNB 200 (e.g., the controller 230) includes a CSI generator 231 that generates CSI based on the SRS received by the receiver 220 from the UE 100. The CSI is information indicating an uplink channel state between the UE 100 and the gNB 200. The gNB 200 (e.g., the data processor A4) performs, for example, uplink scheduling based on the CSI generated based on the SRS.

First, in the model learning, the gNB 200 (receiver 220) receives a first reference signal from the UE 100 by using a first resource. Then, the gNB 200 (model learner A2) derives a learned model for inferring CSI from the reference signal (SRS) by using learning data including the first reference signal. In the description of the second operation scenario, such a first reference signal may be referred to as a full SRS.

For example, the gNB 200 (CSI generator 231) performs channel estimation by using the reception signal (SRS) received by the receiver 220 from the UE 100, and generates CSI. The model learner A2 performs model learning by using a plurality of sets of the reception signal (SRS) and the CSI as the learning data to derive a learned model for inferring the CSI from the reception signal (SRS).

Second, in the model inference, the gNB 200 (receiver 220) receives a second reference signal from the UE 100 by using a second resource that is less than the first resource. Then, the UE 100 (model inferrer A3) uses the learned model to infer the CSI as the inference result data from inference data including the second reference signal. In the description of the second operation scenario, such a second reference signal may be referred to as a partial SRS or a punctured SRS. For a puncture pattern of the SRS, the pattern the same as and/or similar to that in the first operation scenario can be used (see FIGS. 9 and 10).

For example, the gNB 200 (model inferrer A3) uses the reception signal (SRS) received by the receiver 220 from the UE 100 as the inference data, and infers the CSI from the reception signal (SRS) by using the learned model.

This enables the gNB 200 to generate accurate (complete) CSI from a small number of SRSs (partial SRSs) received from the UE 100. For example, the UE 100 may reduce (puncture) the SRS when intended for overhead reduction. The gNB 200 can cope with a situation in which a radio situation deteriorates and some SRSs cannot be normally received.

In such an operation scenario, “CSI-RS”, “gNB 200”, and “UE 100” in the operation of the first operation scenario described above can be read as “SRS”, “UE 100”, and “gNB 200”, respectively.

In the second operation scenario, the gNB 200 transmits reference signal type information as the control data to the UE 100, the reference signal type information indicating a type of either the first reference signal (full SRS) or the second reference signal (partial SRS) to be transmitted by the UE 100. The UE 100 receives the reference signal type information and transmits the SRS designated by the gNB 200 to the gNB 200. This can cause the UE 100 to transmit an appropriated SRS.

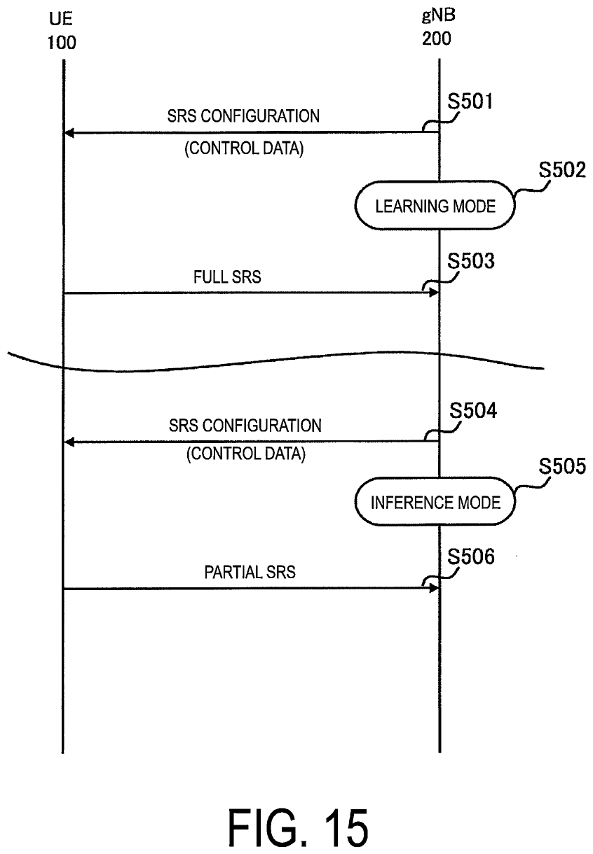

FIG. 15 is an operation flow diagram illustrating an operation example relating to the second operation scenario according to an embodiment.

In step S501, the gNB 200 performs SRS transmission configuration for the UE 100.

In step S502, the gNB 200 starts the learning mode.

In step S503, the UE 100 transmits the full SRS to the gNB 200 in accordance with the configuration in step S501. The gNB 200 receives the full SRS and performs model learning for channel estimation.

In step S504, the gNB 200 specifies the transmission pattern (puncture pattern) of the SRS to be input as the inference data to the learned model, and configures the specified SRS transmission pattern for the UE 100.

In step S505, the gNB 200 transitions to the inference mode and starts the model inference using the learned model.

In step S506, the UE 100 transmits the partial SRS in accordance with the SRS transmission configuration in step S504. When the gNB 200 inputs the SRS as the inference data to the learned model to obtain a channel estimation result, the gNB 200 performs uplink scheduling (e.g., control of uplink transmission weight and the like) of the UE 100 by using the channel estimation result. Note that when the inference accuracy by way of the learned model deteriorates, the gNB 200 may reconfigure so that the UE 100 transmits the full SRS.

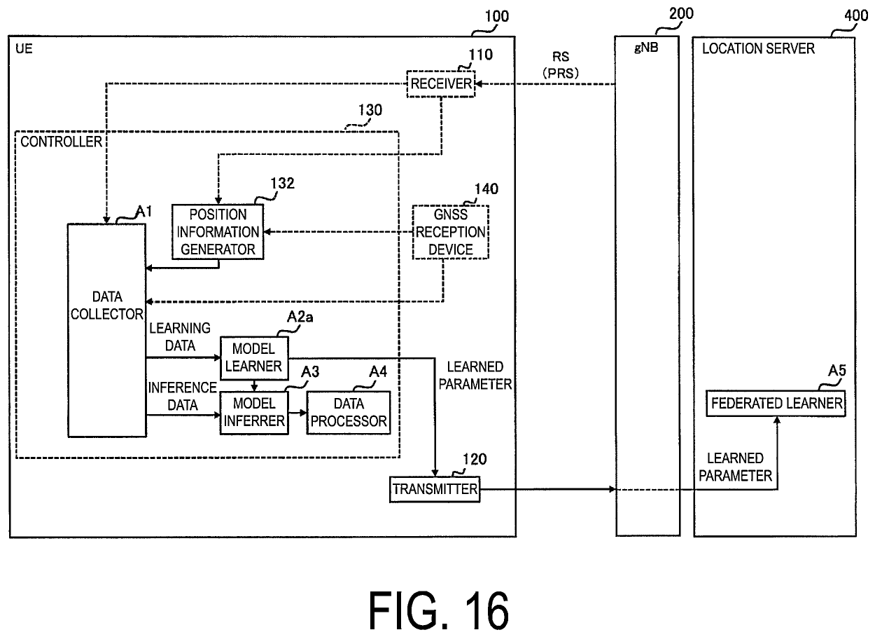

Third Operation Scenario A third operation scenario is described mainly on differences from the first and second operation scenarios. The third operation scenario is an embodiment in which position estimation of the UE 100 (so-called UE positioning) is performed by using federated learning. FIG. 16 is a diagram illustrating the third operation scenario according to an embodiment. In an application example of such federated learning, the following procedure is performed.

First, a location server 400 transmits a model to the UE 100.

Second, the UE 100 performs model learning on the UE 100 (model learner A2) side using the data in the UE 100. The data in the UE 100 may be, for example, a positioning reference signal (PRS) received by the UE 100 from the gNB 200 and/or output data from the GNSS reception device 140. The data in the UE 100 may include position information (including latitude and longitude) generated by the position information generator 132 based on the reception result of the PRS and/or the output data from the GNSS reception device 140.

Third, the UE 100 applies the learned model, which is the learning result, to the UE 100 (model inferrer A3) and transmits variable parameters included in the learned model (hereinafter also referred to as “learned parameters”) to the location server 400. In the above example, the optimized a (slope) and b (intercept) correspond to the learned parameters.

Fourth, the location server 400 (federated learner A5) collects the learned parameters from a plurality of UEs 100 and integrates these parameters. The location server 400 may transmit the learned model obtained by the integration to the UE 100. The location server 400 can estimate the position of the UE 100 based on the learned model obtained by the integration and a measurement report from the UE 100.

In the third operation scenario, the gNB 200 transmits trigger configuration information as the control data to the UE 100, the trigger configuration information configuring a transmission trigger condition for the UE 100 to transmit the learned parameters. The UE 100 receives the trigger configuration information and transmits the learned parameters to the gNB 200 (location server 400) when the configured transmission trigger condition is satisfied. This enables the UE 100 to transmit the learned parameters at an appropriate timing.

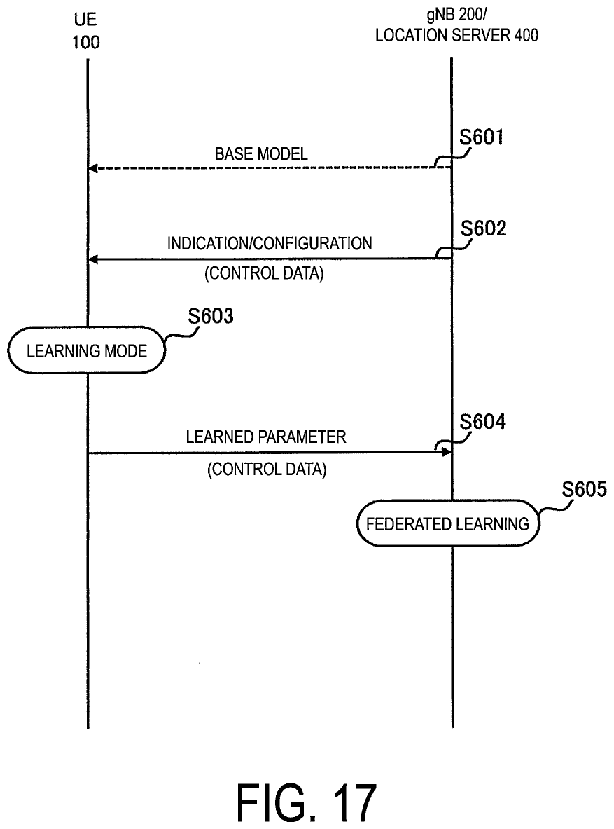

FIG. 17 is an operation flow diagram illustrating an operation example relating to the third operation scenario according to an embodiment.

In step S601, the gNB 200 may transmit a notification indicating a base model that the UE 100 learns. Here, the base model may be a model learned in the past. As described above, the gNB 200 may transmit the data type information indicating what is to be input data to the UE 100.

In step S602, the gNB 200 indicates the model learning to the UE 100 and configures a report timing (trigger condition) of the learned parameter. The configured report timing may be a periodic timing. The report timing may be a timing triggered by learning proficiency satisfying a condition (that is, an event trigger).

For the periodic timing, the gNB 200 sets, for example, a timer value in the UE 100. The UE 100 starts a timer when starting learning (step S603) and reports the learned parameters to the gNB 200 (location server 400) when the timer expires (step S604). The gNB 200 may designate a radio frame or time to be reported to the UE 100. The radio frame may be designated as an absolute value, e.g., SFN=512. The radio frame may be calculated by using a modulo operation. For example, the gNB 200 reports the learned parameters at the SFN that “SFN mod N=0” holds for the UE 100, where N is a set value (step S604).

For the event trigger, the gNB 200 configures the completion condition as described above for the UE 100. The UE 100 reports the learned parameters to the gNB 200 (location server 400) when the completion condition is satisfied (step S604). The UE 100 may trigger the reporting of the learned parameters, for example, when the accuracy of the model inference is better than the previously transmitted model. Here, the UE 100 may introduce an offset to trigger when “current accuracy>previous accuracy+offset” holds. The UE 100 may trigger the reporting of the learned parameters, for example, when the learning data is input (learned) N times or more. Such an offset and/or a value of N may be configured by the gNB 200 for the UE 100.

In step S604, when the condition of the report timing is satisfied, the UE 100 reports the learned parameters at that time to the network (gNB 200).

In step S605, the network (location server 400) integrates the learned parameters reported from a plurality of UEs 100.

### Other Operation Scenarios

The above-described operation scenarios have mainly described the communication between the UE 100 and the gNB 200, but the above-described operation scenarios operations may be applied to communication between the gNB 200 and the AMF 300A (i.e., communication between the base station and the core network). The above-described control data may be transmitted from the gNB 200 to the AMF 300A over the NG interface. The above-described control data may be transmitted from the AMF 300A to the gNB 200 over the NG interface. The AMF 300A and the gNB 200 may exchange a request to perform the federated learning and/or a learning result of the federated learning with each other. The above-described operation scenarios operations may be applied to communication between the gNB 200 and another gNB 200 (i.e., inter-base station communication). The above-described control data may be transmitted from the gNB 200 to the other gNB 200 over the Xn interface. The gNB 200 and the other gNB 200 may exchange a request to perform the federated learning and/or a learning result of the federated learning with each other. The above-described operation scenarios operations may be applied to communication between the UE 100 and another UE 100 (i.e., inter-user equipment communication). The above-described control data may be transmitted from the UE 100 to the other UE 100 over the sidelink. The UE 100 and the other UE 100 may exchange a request to perform the federated learning and/or a learning result of the federated learning with each other. The same applies to the following embodiments.

### Overview of Operation for Model Transfer

An operation for model transfer according to an embodiment is described. In the following description of the embodiment, assume that the model transfer (model configuration) is performed from one communication apparatus to another communication apparatus.

### (1) Notification of Capability Information or Load Status Information

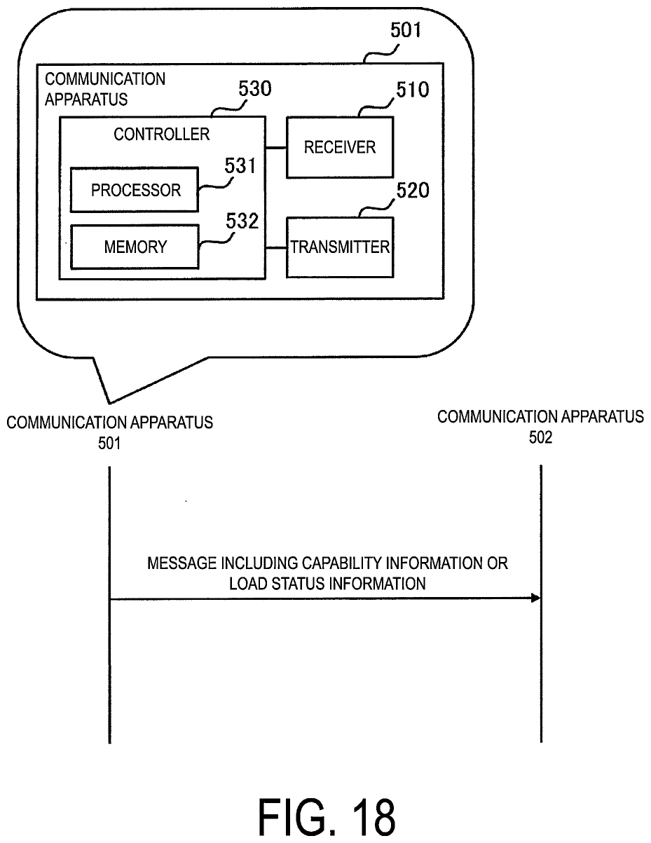

FIG. 18 is a diagram for illustrating capability information or load status information according to an embodiment.

(1.1) A communication apparatus 501 is configured to communicate with a communication apparatus 502 in a mobile communication system 1 using a machine learning technology, the communication apparatus 501 including a controller 530 configured to perform machine learning processing (also referred to as “AI/ML processing”) of learning processing (i.e., model learning) to derive a learned model by using learning data and/or inference processing (i.e., model inference) to infer inference result data from inference data by using the learned model, and a transmitter 520 configured to transmit, to the communication apparatus 502, a message including an information element related to a processing capacity and/or a storage capacity (memory capacity) usable by the communication apparatus 501 for the machine learning processing.

Accordingly, the communication apparatus 502 can appropriately perform configuration and/or configuration change of the model for the communication apparatus 501 based on the message including the information element related to the processing capacity and/or the storage capacity usable by the communication apparatus 501 for the machine learning processing.

(1.2) In (1.1) above, the information element may be an information element indicating execution capability of the machine learning processing in the communication apparatus 501.

(1.3) In (1.2) above, the communication apparatus 501 may further include a receiver 510 configured to receive, from the communication apparatus 502, a transmission request by which the message including the information element is requested to be transmitted. The transmitter 520 may be configured to transmit a message including the information element to the communication apparatus 502 in response to receiving the transmission request.

(1.4) In (1.2) or (1.3) above, the controller 530 may include a processor 531 and/or a memory 532 by which the machine learning processing is performed, and the information element my include information indicating capability of the processor 531 and/or capability of the memory 532.

(1.5) In any one of (1.2) to (1.4) above, the information element may include information indicating execution capability of the inference processing.

(1.6) In any one of (1.2) to (1.5) above, the information element may include information indicating execution capability of the learning processing.

(1.7) In (1.1) above, the information element may be an information element indicating a load status related to the machine learning processing in the communication apparatus 501.

(1.8) In (1.7) above, the communication apparatus 501 may further include a receiver 510 receiver configured to receive, from the communication apparatus 502, information by which transmission of the message including the information element is requested or configured. The transmitter 520 is configured to transmit the message including the information element to the communication apparatus 502 in response to reception of the information by the receiver 510.

(1.9) In (1.7) or (1.8) above, the transmitter 520 may be configured to transmit the message including the information element to the communication apparatus 502 in response to a value indicating the load status satisfying a threshold condition or in a periodic manner.

(1.10) In any one of (1.7) to (1.9) above, the controller 530 may include a processor 531 and/or a memory 532 by which the machine learning processing is performed, and the information element may include information indicating a load status of the processor 531 and/or a load status of the memory 532.

(1.11) In any one of (1.1) to (1.10) above, the transmitter 520 may be configured to transmit, to the communication apparatus 502, the message including the information element and a model identifier associated with the information element, and the model identifier may be an identifier by which a model in machine learning is identified.

(1.12) In any one of (1.1) to (1.11) above, the communication apparatus 501 may further include a receiver 510 configured to receive, from the separate communication apparatus 502, a model used for the machine learning processing after the message is transmitted.

(1.13) In any one of (1.1) to (1.12) above, the communication apparatus 502 may be a base station (gNB 200) or a core network apparatus (e.g., the AMF 300A), and the communication apparatus 501 may be a user equipment (UE 100).

(1.14) In (1.13) above, the communication apparatus 502 may be the base station, and the message may be an RRC message.

(1.15) In (1.13) above, the communication apparatus 502 may be the core network apparatus, and the message may be a NAS message.

(1.16) In any one of (1.1) to (1.12) above, the communication apparatus 502 may be a core network apparatus, and the communication apparatus 501 may be a base station.

(1.17) In any one of (1.1) to (1.12) above, the communication apparatus 502 may be a first base station, and the communication apparatus 501 may be a second base station.

(1.18) A communication method is performed by a communication apparatus 501 configured to communicate with a communication apparatus 502 in a mobile communication system 1 using a machine learning technology, the method including performing machine learning processing of learning processing to derive a learned model by using learning data and/or inference processing to infer inference result data from inference data by using the learned model, and transmitting, to the communication apparatus 502, a message including an information element related to a processing capacity and/or a storage capacity usable by the communication apparatus 501 for the machine learning processing.

### (2) Configuration of Model

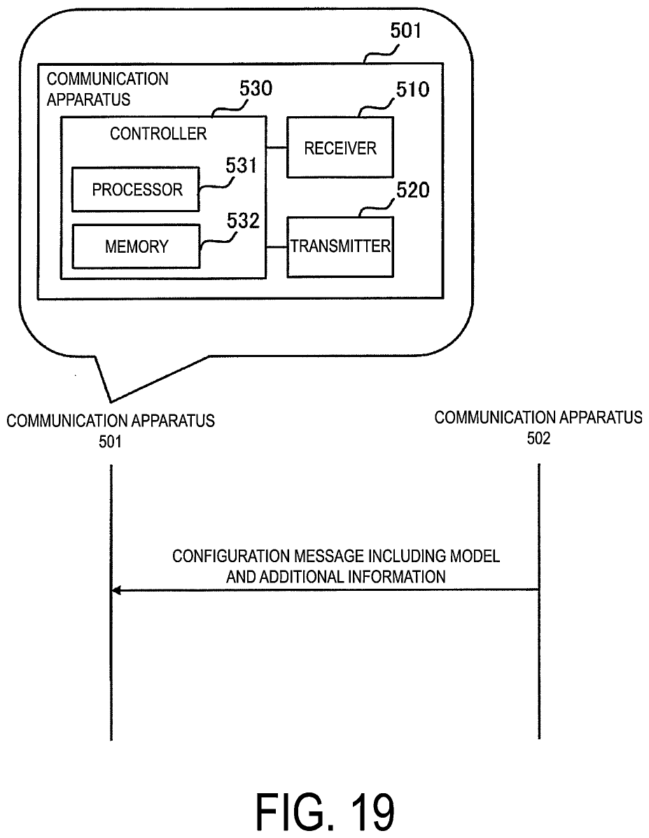

FIG. 19 is a diagram for illustrating a configuration of a model according to an embodiment.

(2.1) The communication apparatus 501 is configured to communicate with the communication apparatus 502 in the mobile communication system 1 using the machine learning technology, the communication apparatus 501 including the receiver 510 configured to receive, from the communication apparatus 502, a configuration message including a model and additional information on the model, the model being used in the machine learning processing of the learning processing and/or the inference processing, and the controller 530 configured to perform the machine learning processing using the model based on the additional information.

Accordingly, the model can be appropriately configured by the communication apparatus 502 for the communication apparatus 501.

(2.2) In (2.1) above, the model may be a learned model used in the inference processing.

(2.3) In (2.1) above, the model may be an unlearned model used in the learning processing.

(2.4) In any one of (2.1) to (2.3) above, the message may include a plurality of models including the model, and additional information associated with each of the plurality of models individually or in common.

(2.5) In any one of (2.1) to (2.4) above, the additional information may include an index of the model.

(2.6) In any one of (2.1) to (2.5) above, the additional information may include information indicating an application of the model and/or information indicating a type of input data to the model.

(2.7) In any one of (2.1) to (2.6) above, the additional information may include information indicating performance required for applying the model.

(2.8) In any one of (2.1) to (2.7) above, the additional information may include information indicating a criterion for applying the model.

(2.9) In any one of the above (2.1) to (2.8) above, the additional information may include information indicating whether the model is required to be learned or relearned and/or whether the model can be learned or relearned.

(2.10) In any one of (2.1) to (2.9) above, the controller 530 may be configured to deploy the model in response to receiving a message, and the communication apparatus 501 may further include the transmitter 520 configured to transmits, to the communication apparatus 502, a response message indicating that the deployment of the model is completed.

(2.11) In the above (2.10), when the deployment of the model is failed, the transmitter 520 may be configured to transmit an error message to the communication apparatus 502.

(2.12) In any one of (2.1) to (2.11) above, the message may be a message for configuring the model for the user equipment, the receiver 510 may be configured to further receive an activation command for applying the configured model from the communication apparatus 502, and the controller 530 may be configured to deploy the model in response to receiving the message and activate the deployed model in response to receiving the activation command.

(2.13) In (2.12) above, the activation command may include an index indicating the model to be applied.

(2.14) In any one of (2.1) to (2.13) above, the receiver 510 may be configured to further receive a delete message indicating deletion of the model configured by the configuration message, and the controller 530 may be configured to delete the model configured by the configuration message in response to receiving the delete message.

(2.15) In any one of (2.1) to (2.14) above, when a plurality of divided messages obtained by dividing the configuration message are transmitted from the communication apparatus 502, the receiver 510 may be configured to receive, from the communication apparatus 502, information indicating a transmission method of transmitting the plurality of divided messages.

(2.16) In any one of (2.1) to (2.15) above, the communication apparatus 502 may be a base station or a core network apparatus, and the communication apparatus 501 may be a user equipment.

(2.17) In (2.16) above, the communication apparatus 502 may be the base station and the message may be an RRC message.

(2.18) In (2.16) above, the communication apparatus 502 may be the core network apparatus and the message may be a NAS message.

(2.19) In any one of (2.1) to (2.15) above, the communication apparatus 502 may be a core network apparatus and the communication apparatus 501 may be a base station, or the communication apparatus 502 may be a first base station and the communication apparatus 501 may be a second base station.

(2.20) A communication method is performed by the communication apparatus 501 configured to communicate with the communication apparatus 502 in the mobile communication system 1 using the machine learning technology, the method including receiving, from the communication apparatus 502, a configuration message including a model and additional information on the model, the model being used in the machine learning processing of the learning processing and/or the inference processing, and performing the machine learning processing using the model based on the additional information.

### First Operation Example for Model Transfer

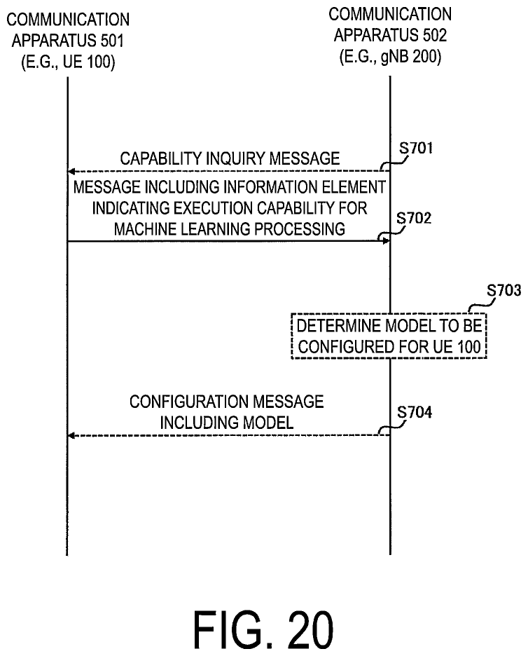

FIG. 20 is a diagram illustrating a first operation example for the model transfer according to an embodiment. In the drawings referenced in first to third operation examples described below, non-essential processing is indicated by a dashed line. In the first to third operation examples described below, assume that the communication apparatus 501 is the UE 100, but the communication apparatus 501 may be the gNB 200 or the AMF 300A. In the first to third operation examples described below, assume that the communication apparatus 502 is the gNB 200, but the communication apparatus 502 may be the UE 100 or the AMF 300A.

As illustrated in FIG. 20, in step S701, the gNB 200 transmits, to the UE 100, a capability inquiry message for requesting transmission of the message including the information element indicating the execution capability for the machine learning processing.

The capability inquiry message is an example of the transmission request for requesting transmission of the message including the information element indicating the execution capability for the machine learning processing. The UE 100 receives the capability inquiry message. However, the gNB 200 may transmit the capability inquiry message when performing the machine learning processing (when determining to perform the machine learning process).

In step S702, the UE 100 transmits, to the gNB 200, the message including the information element indicating the execution capability (an execution environment for the machine learning processing, from another viewpoint) for the machine learning processing. The gNB 200 receives the message. The message may be an RRC message, for example, a “UE Capability” message defined in the RRC technical specifications, or a newly defined message (e.g., a “UE A1 Capability” message or the like). The communication apparatus 502 may be the AMF 300A and the message may be a NAS message. When a new layer for performing or controlling the machine learning processing (AI/ML processing) is defined, the message may be a message of the new layer. The new layer is adequately referred to as an “AI/ML layer”.

The information element indicating the execution capability for the machine learning processing is at least one selected from group consisting of the information elements (A1) to (A3) below.

### Information Element (A1)

The information element (A1) is an information element indicating capability of the processor for performing the machine learning processing and/or an information element indicating capability of the memory for performing the machine learning processing.

The information element indicating the capability of the processor for performing the machine learning processing may be an information element indicating whether the UE 100 includes an A1 processor. When the UE 100 includes the processor, the information element may include an A1 processor product number (model number). The information element may be an information element indicate whether a Graphics Processing Unit (GPU) is usable by the UE 100. The information element may be an information element indicating whether the machine learning processing needs to be performed by the CPU. The information element indicating the capability of the processor for performing the machine learning processing being transmitted from the UE 100 to the gNB 200 allows the network side to determine whether a neural network model is usable as a model by the UE 100, for example. The information element indicating the capability of the processor for performing the machine learning processing may be an information element indicating a clock frequency and/or the number of parallel executables for the processor.

The information element indicating the capability of the memory for performing the machine learning processing may be an information element indicating a memory capacity of a volatile memory (e.g., a Random Access Memory (RAM)) of the memories of the UE 100. The information elements may be an information element indicating a memory capacity of a non-volatile memory (e.g., a Read Only Memory (ROM)) of the memories of the UE 100. The information element may indicate both of these. The information element indicating the capability of the memory for performing the machine learning processing may be defined for each type such as a model storage memory, an A1 processor memory, or a GPU memory.

The information element (A1) may be defined as an information element for the inference processing (model inference). The information element (A1) may be defined as an information element for the learning processing (model learning). Both the information element for the inference processing and the information element for the learning processing may be defined as the information element (A1).

### Information Element (A2)

The information element (A2) is an information element indicating the execution capability for the inference processing. The information element (A2) may be an information element indicating a model supported in the inference processing. The information element may be an information element indicating whether a deep neural network model is able to be supported. In this case, the information element may include at least one selected from the group consisting of information indicating the number of supportable layers (stages) of a neural network, information indicating the number of supportable neurons (which may be the number of neurons per layer), and information indicating the number of supportable synapses (which may be the number of input or output synapses per layer or per neuron).

The information element (A2) may be an information element indicating an execution time (response time) required to perform the inference processing. The information element (A2) may be an information element indicating the number of simultaneous executions of the inference processing (e.g., how many pieces of inference processing can be performed in parallel). The information element (A2) may be an information element indicating the processing capacity of the inference processing. For example, when a processing load for a certain standard model (standard task) is determined to be one point, the information element indicating the processing capacity of the inference processing may be information indicating how many points the processing capacity of the inference processing itself is.

### Information Element (A3)

The information element (A3) is an information element indicating the execution capability for the learning processing. The information element (A3) may be an information element indicating a learning algorithm supported in the learning processing. Examples of the learning algorithm indicated by the information element include supervised learning (e.g., linear regression, decision tree, logistic regression, k-nearest neighbor algorithm, and support vector machine), unsupervised learning (e.g., clustering, k-means, and principal component analysis), reinforcement learning, and deep learning. When the UE 100 supports deep learning, the information element may include at least one selected from the group consisting of information indicating the number of supportable layers (stages) of a neural network, information indicating the number of supportable neurons (which may be the number of neurons per layer), and information indicating the number of supportable synapses (which may be the number of input or output synapses per layer or per neuron).

The information element (A3) may be an information element indicating an execution time (response time) required to perform the learning processing. The information element (A3) may be an information element indicating the number of simultaneous executions of the learning processing (e.g., how many pieces of learning processing can be performed in parallel). The information element (A3) may be an information element indicating the processing capacity of the learning processing. For example, when a processing load for a certain standard model (standard task) is determined to be one point, the information element indicating the processing capacity of the learning processing may be information indicating how many points the processing capacity of the learning processing itself is. Note that since the processing load of the learning processing is generally higher than that of the inference processing, the number of simultaneous executions may be information such as the number of simultaneous executions with the inference processing (e.g., two pieces of inference processing and one piece of learning processing).

In step S703, the gNB 200 determines a model to be configured (deployed) for the UE 100 based on the information element included in the message received in step S702. The model may be a learned model used by the UE 100 in the inference processing. The model may be an unlearned model used by the UE 100 in the learning processing.

In step S704, the gNB 200 transmits a message including the model determined in step S703 to the UE 100. The UE 100 receives the message and performs the machine learning processing (learning processing and/or inference processing) using the model included in the message. A concrete example of step S704 is described in the second operation example below.

### Second Operation Example for Model Transfer

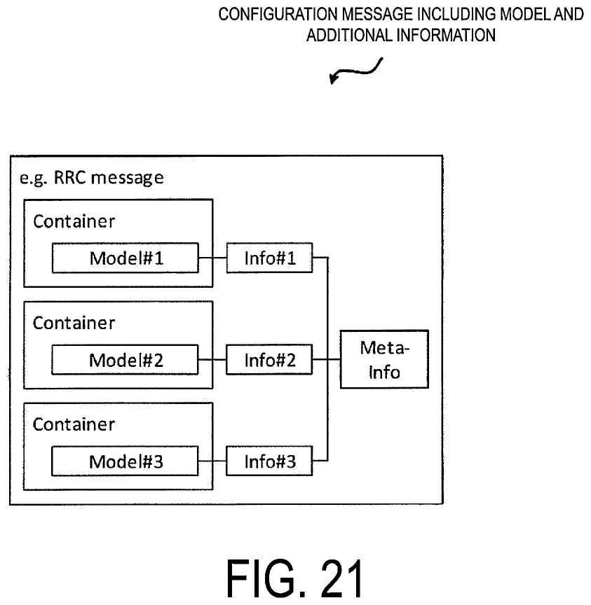

FIG. 21 is a diagram illustrating an example of the configuration message including the model and the additional information according to the embodiment. The configuration message may be an RRC message transmitted from the gNB 200 to the UE 100, for example, an “RRC Reconfiguration” message defined in the RRC technical specifications, or a newly defined message (such as an “A1 Deployment” message or an “A1 Reconfiguration” message). The configuration message may be a NAS message transmitted from the AMF 300A to the UE 100.

When a new layer for performing or controlling the machine learning processing (AI/ML processing) is defined, the message may be a message of the new layer.

In the example of FIG. 21, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

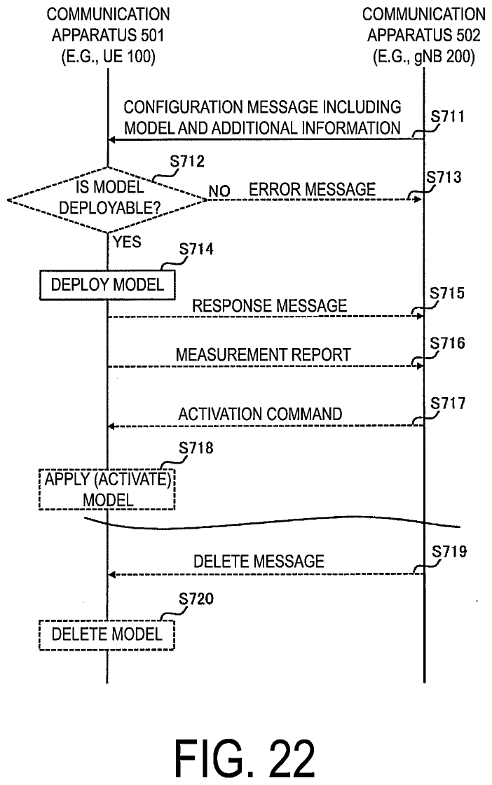

FIG. 22 is a diagram illustrating the second operation example for the model transfer according to an embodiment.

In step S711, the gNB 200 transmits a configuration message including a model and additional information to the UE 100. The UE 100 receives the configuration message. The configuration message includes at least one selected from the group consisting of the information elements (B1) to (B6) below.

### (B1) Model

The “model” may be a learned model used by the UE 100 in the inference processing. The “model” may be an unlearned model used by the UE 100 in the learning processing. In the configuration message, the “model” may be encapsulated (containerized). When the “model” is a neural network model, the “model” may be represented by the number of layers (stages), the number of neurons per layer, a synapse (weight) between the neurons, and the like. For example, a learned (or unlearned) neural network model may be represented by a combination of matrices.

A plurality of “models” may be included in one configuration message. In this case, the plurality of “models” may be included in the configuration message in a list format. The plurality of “models” may be configured for the same application or may be configured for different applications. The application of the model is described in detail below.

### (B2) Model Index

A “model index” is an example of the additional information (e.g., individual additional information). The “model index” is an index (index number) assigned to a model. In the activation command and the delete message described below, a model can be designated by the “model index”. When the configuration change of the model is performed, a model can be designated by the “model index” as well.

### (B3) Model Application

The “model application” is an example of the additional information (individual additional information or common additional information). The “model application” designates a function to which a model is applied. For example, the functions to which the model is applied include CSI feedback, beam management (beam estimation, overhead latency reduction, beam selection accuracy improvement), positioning, modulation and demodulation, coding and decoding (CODEC), and packet compression. The contents of the model application and indexes (identifiers) thereof may be predefined in the 3GPP technical specifications, and the “model application” may be designated by the index. For example, the model application and the index (identifier) thereof are defined such that the CSI feedback is assigned with an application index #A and the beam management is assigned with an application index #B. The UE 100 deploys the model for which the “model application” is designated to the functional block corresponding to the designated application. Note that the “model application” may be an information element that designates input data and output data of a model.

### (B4) Model Execution Requirement

A “model execution requirement” is an example of the additional information (e.g., individual additional information). The “model execution requirement” is an information element indicating performance (required performance) required to apply (execute) the model, for example, a processing delay (request latency).

### (B5) Model Selection Criterion

A “model selection criterion” is an example of the additional information (individual additional information or common additional information). In response to a criterion designated by the “model selection criterion” being met, the UE 100 applies (executes) the corresponding model. The “model selection criterion” may be the migration speed of the UE 100. In this case, the “model selection criterion” may be designated by a speed range such as “low-speed migration” or “high-speed migration”. The “model selection criterion” may be designated by a threshold value of the migration speed. The “model selection criterion” may be a radio quality (e.g., RSRP/RSRQ/SINR) measured in the UE 100. In this case, the “model selection criterion” may be designated by a range of the radio quality. The “model selection criterion” may be designated by a threshold value of the radio quality. The “model selection criterion” may be a position (latitude/longitude/altitude) of the UE 100. As the “model selection criterion”, a notification (activation command described below) from a sequential network may be configured to be conformed, or an autonomous selection by the UE 100 may be designated.

### (B6) Whether to Require Learning Processing

The “whether to require learning processing” is an information element indicating whether the learning processing (or relearning) on the corresponding model is required or is able to be performed. When the learning processing is required, parameter types used for the learning processing may be further configured. For example, for the CSI feedback, the CSI-RS and the UE migration speed are configured to be used as parameters. When the learning processing is required, a method of the learning processing, for example, supervised learning, unsupervised learning, reinforcement learning, or deep learning may be further configured. Whether the learning processing is performed immediately after the model is configured may be further configured. When the learning processing is not performed immediately, learning execution may be controlled by the activation command described below. For example, for the federated learning, whether to notify the gNB 200 of a result of the learning processing of the UE 100 may be further configured. When a notification of the result of the learning processing of the UE 100 is required to be provided to the gNB 200, the UE 100, after performing the learning processing, may encapsulate and transmit the learned model or the learned parameter to the gNB 200 by using an RRC message or the like. The information element indicating “whether to require learning processing” may be an information element indicating, in addition to whether to require learning processing, whether the corresponding model is used only for the model inference.

In step S712, the UE 100 determines whether the model configured in step S711 is deployable (executable). The UE 100 may make this determination at the time of activation of the model, which is described below, and in step S713, which is described later, a message may be transmitted for a notification of an error at the time of the activation. The UE 100 may make the determination during using the model (during performing the machine learning processing) instead of the time of the deployment or the activation. When the model is determined to be non-deployable (NO in step S712), that is, when an error occurs, in step S713, the UE 100 transmits an error message to the gNB 200. The error message may be an RRC message transmitted from the UE 100 to the gNB 200, for example, a “Failure Information” message defined in the RRC technical specifications, or a newly defined message (e.g., an “A1 Deployment Failure Information” message). The error message may be Uplink Control Information (UCI) defined in the physical layer or a MAC control element (CE) defined in the MAC layer. The error message may be a NAS message transmitted from the UE 100 to the AMF 300A. When a new layer (AI/ML layer) for performing the machine learning processing (AI/ML processing) is defined, the message may be a message of the new layer.

The error message includes at least one selected from the group consisting of the information elements (C1) to (C3).

### (C1) Model Index

This is a model index of the model determined to be non-deployable.

### (C2) Application Index

This is an application index of the model determined to be non-deployable.

### (C3) Error Cause

This is an information element related to a cause of an error. The “error cause” may be, for example, “unsupported model”, “processing capacity exceeded”, “error occurrence phase”, or “other errors”. Examples of the “unsupported model” include, for example, a model that the UE 100 cannot support a neural network model, and a model that the machine learning processing (AI/ML processing) of a designated function cannot be supported. Examples of the “processing capacity exceeded” include, for example, an overload (a processing load or a memory load exceeds a capacity), a request processing time being not able to be satisfied, and an interrupt processing or a priority processing of an application (upper layer). The “error occurrence phase” is information indicating when an error has occurred. The “error occurrence phase” may include a classification such as a time of deployment (configuration) time, a time of activation time, or a time of operation. The “error occurrence phase” may include a classification such as a time of inference processing or a time of learning processing. The “other errors” include other causes.

The UE 100 may automatically delete the corresponding model when an error occurs. The UE 100 may delete the model when confirming that an error message is received by the gNB 200, for example, when an ACK is received at the lower layer. The gNB 200, when receiving an error message from the UE 100, may recognize that the model has been deleted.

On the other hand, when the model configured in step S711 is determined to be deployable (YES in step S712), that is, when no error occurs, in step S714, the UE 100 deploys the model in accordance with the configuration. The “deployment” may mean bringing the model into an applicable state. The “deployment” may mean actually applying the model. In the former case, the model is not applied when the model is only deployed, but the model is applied when the model is activated by the activation command described below. In the latter case, once the model is deployed, the model is brought into a state of being used.

In step S715, the UE 100 transmits a response message to the gNB 200 in response to the model deployment being completed. The gNB 200 receives the response message. The UE 100 may transmit the response message when the activation of the model is completed by the activation command described below. The response message may be an RRC message transmitted from the UE 100 to the gNB 200, for example, an “RRC Reconfiguration Complete” message defined in the RRC technical specifications, or a newly defined message (e.g., an “A1 Deployment Complete” message). The response message may be a MAC CE defined in the MAC layer. The response message may be a NAS message transmitted from the UE 100 to the AMF 300A. When a new layer for performing the machine learning processing (AI/ML processing) is defined, the message may be a message of the new layer.

In step S716, the UE 100 may transmit a measurement report message to the gNB 200, the measurement report message being an RRC message including a measurement result of a radio environment. The gNB 200 receives the measurement report message.

In step S717, the gNB 200 selects a model to be activated, for example, based on the measurement report message, and transmits an activation command (selection command) for activating the selected model to the UE 100. The UE 100 receives the activation command. The activation command may be DCI, a MAC CE, an RRC message, or a message of the AI/ML layer. The activation command may include a model index indicating the selected model. The activation command may include information designating whether the UE 100 performs the inference processing or whether the UE 100 performs the learning processing.

The gNB 200 selects a model to be deactivated, for example, based on the measurement report message, and transmits a deactivation command (selection command) for deactivating the selected model to the UE 100. The UE 100 receives the deactivation command.

The deactivation command may be DCI, a MAC CE, an RRC message, or a message of the AI/ML layer. The deactivation command may include a model index indicating the selected model. The UE 100, upon receiving the deactivation command, may not need to delete but may deactivate (cease to apply) the designate model.

In step S718, the UE 100 applies (activates) the designated model in response to receiving the activation command. The UE 100 performs the inference processing and/or the learning processing using the activated model from among the deployed models.

In step S719, the gNB 200 transmits a delete message to delete the model to the UE 100. The UE 100 receives the delete message. The delete message may be a MAC CE, an RRC message, a NAS message, or a message of the AI/ML layer. The delete message may include the model index of the model to be deleted. The UE 100, upon receiving the delete message, deletes the designated model.

Note that it may be difficult to include a model in one message when an amount of data of model and/or the number of models, transmitted (transferred) from the gNB 200 to the UE 100, is large. Therefore, the gNB 200 may divide the configuration message including the model into a plurality of divided messages and sequentially transmit the divided messages. In this case, the gNB 200 notifies the UE 100 of a transmission method of the divided messages.

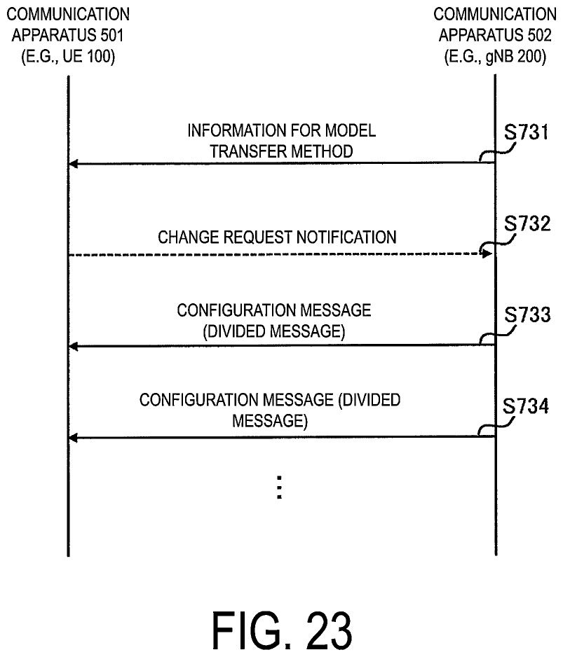

FIG. 23 is a diagram illustrating an operation example for divided configuration message transmission according to an embodiment.

In step S731, the gNB 200 transmits a message including information for a model transfer method to the UE 100. The UE 100 receives the message. The message includes at least one information element of the group consisting of “size of transmission data”, “time until completion of delivery”, “total capacity for data”, and “transmission method and transmission condition”. The “transmission method and transmission condition” includes at least one piece of information of the group consisting of “continuous configuration”, “period (periodic or non-periodic) configuration”, “transmission time of day and transmission time (e.g., two hours from 24:00 every day)”, “conditional transmission (e.g., transmission when no battery concern is present (example: only when charging) or transmission only when a resource is free)”, and “designation of a bearer, a communication path, and a network slice”.

In step S732, the UE 100 determines whether the data transmission method/transmission condition transmitted in the notification from the gNB 200 in step S731 is desired, and when determining not desired, transmits to the gNB 200 a change request notification for requesting a change. The gNB 200 may perform step S731 again in response to the change request notification.

In steps S733, S734, . . . , the gNB 200 transmits a divided message to the UE 100. The UE 100 receives the divided message. The gNB 200, during such data transmission, may transmit, to the UE 100, information indicating an amount of transmitted data and/or an amount of remaining data, for example, information indicating “the number of pieces of transmitted data and the total number of pieces of data” or “a ratio (%) of transmitted data”. The UE 100 may transmit a transmission stop request or transmission resume request of the divided message to the gNB 200 according to convenience of the UE 100. The gNB 200 may transmit a transmission stop notification or transmission resume notification of the divided message to the UE 100 according to convenience of the gNB 200.

Note that the gNB 200 may notify the UE 100 of the amount of data of the model (configuration message) and start transmission of the model only when an approval is obtained from the UE 100. For example, the UE 100 may return OK when the model is deployable and NG when the model is non-deployable, in comparison to the remaining memory capacity of the UE 100. The other information may be negotiated between the transmission side and the reception side in a manner as described above.

### Third Operation Example for Model Transfer

In the third operation example, the UE 100 notifies the network of the load status of the machine learning processing (AI/ML processing). This allows the network (e.g., the gNB 200) to determine how many more models can be deployed (or activated) in the UE 100 based on the load status transmitted in the notification. The third operation example may not need to be premised on the first operation example for the model transfer described above. The third operation example may be premised on the first operation example.

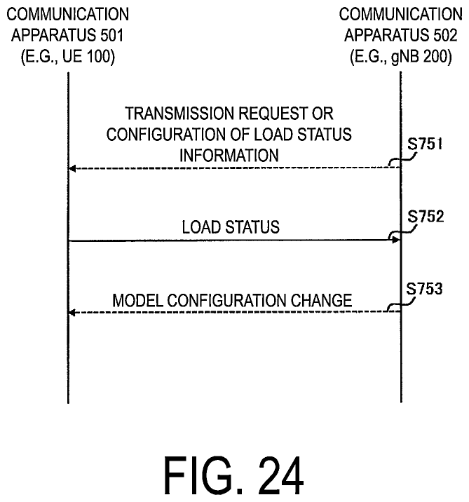

FIG. 24 is a diagram illustrating the third operation example for the model transfer according to an embodiment.

In step S751, the gNB 200 transmits a message, to the UE 100, a message including a request for providing information on the AI/ML processing load status or a configuration of AI/ML processing load status reporting. The UE 100 receives the message. The message may be a MAC CE, an RRC message, a NAS message, or a message of the AI/ML layer. The configuration of AI/ML processing load status reporting may include information for configuring a report trigger (transmission trigger), for example, “Periodic” or “Event triggered”. “Periodic” configures a reporting period, and the UE 100 performs reporting in the period. “Event triggered” configures a threshold to be compared with a value (processing load value and/or memory load value) indicating the AI/ML processing load status in the UE 100, and the UE 100 performs reporting in response to the value satisfying a condition of the threshold. Here, the threshold may be configured for each model. For example, in the message, the model index and the threshold may be associated with each other.

In step S752, the UE 100 transmits a message (report message) including the AI/ML processing load status to the gNB 200. The message may be an RRC message, for example, a “UE Assistance Information” message or “Measurement Report” message. The message may be a newly defined message (e.g., an “A1 Assistance Information” message). The message may be a NAS message or a message of the AI/ML layer message.

The message includes a “processing load status” and/or a “memory load status”. The “processing load status” may indicate what percentage of processing capability (capability of the processor) is already used or what remaining percentage is usable. The “processing load status” may indicate, with the load expressed in points as described above, how many points are already used and how many remaining points is usable. The UE 100 may indicate the “processing load status” for each model. For example, the UE 100 may include at least one set of “model index” and “processing load status” in the message. The “memory load status” may indicate a memory capacity, a memory usage amount, or a memory remaining amount. The UE 100 may indicate the “memory load status” for each type such as a model storage memory, an A1 processor memory, and a GPU memory.

In step S752, when the UE 100 wants to stop using a particular model, for example, because of a high processing load or inefficiency, the UE 100 may include in the message information (model index) indicating a model of which configuration deletion or deactivation of model is wanted. When the processing load of the UE 100 becomes unsafe, the UE 100 may transmit the message including alert information to the gNB 200.

In step S753, the gNB 200 determines configuration change of the model or the like based on the message received from the UE 100 in step S752, and transmits a message for model configuration change to the UE 100. The message may be a MAC CE, an RRC message, a NAS message, or a message of the AI/ML layer. The gNB 200 may transmit the activation command or deactivation command described above to the UE 100.

### OTHER EMBODIMENTS

As described above, in the drawings referred to in the first to third operation examples for the model transfer, non-essential processing is indicated by a dashed line. In the first to third operation examples, the communication apparatus 501 is the UE 100, but the communication apparatus 501 may be the gNB 200 or the AMF 300A. The communication apparatus 501 may be a gNB-DU or a gNB-CU, which is a functional division unit of the gNB 200. The communication apparatus 501 may be one or more radio units (RUs) included in the gNB-DU. In the first to third operation examples, the communication apparatus 502 is the gNB 200, but the communication apparatus 502 may be the UE 100 or the AMF 300A. The communication apparatus 502 may be a gNB-CU, a gNB-DU, or an RU. Assuming sidelink relay, the communication apparatus 501 may be a remote UE, and the communication apparatus 502 may be a relay UE.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node. The user equipment (terminal apparatus) may be a relay node such as an IAB node or a Mobile Termination (MT) of the IAB node.

A program causing a computer to execute each piece of the processing performed by the communication apparatus (e.g., UE 100 or gNB 200) may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for performing each piece of processing performed by the communication apparatus may be integrated, and at least part of the communication apparatus may be configured as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be an exclusive “or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

Supplementary Note Features relating to the embodiments described above are described below as supplements.

(1)

A communication apparatus configured to communicate with another communication apparatus different from the communication apparatus in a mobile communication system using a machine learning technology, the communication apparatus including:
a controller configured to perform machine learning processing of learning processing to derive a learned model by using learning data and/or inference processing to infer inference result data from inference data by using the learned model; and
a transmitter configured to transmit, to the other communication apparatus, a message including an information element related to a processing capacity and/or a storage capacity usable by the communication apparatus for the machine learning processing.

(2)

The communication apparatus according to (1) above, wherein
the information element is an information element indicating execution capability of the machine learning processing in the communication apparatus.

(3)

The communication apparatus according to (1) or (2) above, further including:
a receiver configured to receive, from the other communication apparatus, a transmission request by which the message including the information element is requested to be transmitted, wherein the transmitter is configured to transmit the message including the information element to the other communication apparatus in response to receiving the transmission request.

(4)

The communication apparatus according to any one of (1) to (3) above, wherein
the controller includes a processor and/or a memory by which the machine learning processing is performed, and
the information element includes information indicating capability of the processor and/or capability of the memory.

(5)

The communication apparatus according to any one of (1) to (4) above, wherein
the information element includes information indicating execution capability of the inference processing.

(6)

The communication apparatus according to any one of (1) to (5) above, wherein
the information element includes information indicating execution capability of the learning processing.

(7)

The communication apparatus according to any one of (1) to (6) above, wherein
the information element is an information element indicating a load status related to the machine learning processing in the communication apparatus.

(8)

The communication apparatus according to (7) above, further including:
a receiver configured to receive, from the other communication apparatus, information by which transmission of the message including the information element is requested or configured,
wherein the transmitter is configured to transmit the message including the information element to the other communication apparatus in response to reception of the information by the receiver.

(9)

The communication apparatus according to (7) or (8) above, wherein
the transmitter is configured to transmit the message including the information element to the other communication apparatus in response to a value indicating the load status satisfying a threshold condition or in a periodic manner.

(10)

The communication apparatus according to any one of (7) to (9) above, wherein
the controller includes a processor and/or a memory by which the machine learning processing is performed, and
the information element includes information indicating a load status of the processor and/or a load status of the memory.

(11)

The communication apparatus according to any one of (1) to (10) above, wherein
the transmitter is configured to transmit, to the other communication apparatus, the message including the information element and a model identifier associated with the information element, and
the model identifier is an identifier by which a model in machine learning is identified.

(12)

The communication apparatus according to any one of (1) to (11) above, further including:
a receiver configured to receive, from the other communication apparatus, a model used for the machine learning processing after the message is transmitted.

(13)

The communication apparatus according to any one of any one of (1) to (12) above, wherein
the other communication apparatus is a base station or a core network apparatus, and the communication apparatus is a user equipment.

(14)

The communication apparatus according to (13) above, wherein
the other communication apparatus is the base station, and the message is an RRC message.

(15)

The communication apparatus according to (13) above, wherein
the other communication apparatus is the core network apparatus, and the message is a NAS message.

(16)

The communication apparatus according to any one of (1) to (12) above, wherein
the other communication apparatus is a core network apparatus, and the communication apparatus is a base station.

(17)

The communication apparatus according to any one of (1) to (12) above, wherein
the other communication apparatus is a first base station, and the communication apparatus is a second base station.

(18)

A communication method performed by a communication apparatus configured to communicate with another communication apparatus different from the communication apparatus in a mobile communication system using a machine learning technology, the communication method including:
performing machine learning processing of learning processing to derive a learned model by using learning data and/or inference processing to infer inference result data from inference data by using the learned model; and
transmitting, to the other communication apparatus, a message including an information element related to a processing capacity and/or a storage capacity usable by the communication apparatus for the machine learning processing.

### REFERENCE SIGNS

1: Mobile communication system
100: UE
110: Receiver
120: Transmitter
130: Controller
131: CSI generator
132: Position information generator
140: GNSS reception device
200: gNB
210: Transmitter
220: Receiver
230: Controller
231: CSI generator
240: Backhaul communicator
400: Location server
501 Communication apparatus
502 Communication apparatus
A1: Data collector
A2: Model learner
A3: Model inferrer
A4: Data processor
A5: Federated learner

1. A communication apparatus configured to communicate with another communication apparatus different from the communication apparatus in a mobile communication system using a machine learning technology, the communication apparatus comprising:
a controller configured to perform machine learning processing of learning processing to derive a learned model by using learning data and/or inference processing to infer inference result data from inference data by using the learned model; and
a transmitter configured to transmit, to the other communication apparatus, a message comprising an information element related to a processing capacity and/or a storage capacity usable by the communication apparatus for the machine learning processing.

2. The communication apparatus according to claim 1, wherein
the information element is an information element indicating execution capability of the machine learning processing in the communication apparatus.

3. The communication apparatus according to claim 2, further comprising:
a receiver configured to receive, from the other communication apparatus, a transmission request by which the message comprising the information element is requested to be transmitted,
wherein the transmitter is configured to transmit the message comprising the information element to the other communication apparatus in response to receiving the transmission request.

4. The communication apparatus according to claim 2, wherein
the controller comprises a processor and/or a memory by which the machine learning processing is performed, and
the information element comprises information indicating capability of the processor and/or capability of the memory.

5. The communication apparatus according to claim 2, wherein
the information element comprises information indicating execution capability of the inference processing.

6. The communication apparatus according to claim 2, wherein
the information element comprises information indicating execution capability of the learning processing.

7. The communication apparatus according to claim 1, wherein
the information element is an information element indicating a load status related to the machine learning processing in the communication apparatus.

8. The communication apparatus according to claim 7, further comprising:
a receiver configured to receive, from the other communication apparatus, information by which transmission of the message comprising the information element is requested or configured,
wherein the transmitter is configured to transmit the message comprising the information element to the other communication apparatus in response to reception of the information by the receiver.

9. The communication apparatus according to claim 7, wherein
the transmitter is configured to transmit the message comprising the information element to the other communication apparatus in response to a value indicating the load status satisfying a threshold condition or in a periodic manner.

10. The communication apparatus according to claim 7, wherein
the controller comprises a processor and/or a memory by which the machine learning processing is performed, and
the information element comprises information indicating a load status of the processor and/or a load status of the memory.

11. The communication apparatus according to claim 1, wherein
the transmitter is configured to transmit, to the other communication apparatus, the message comprising the information element and a model identifier associated with the information element, and
the model identifier is an identifier by which a model in machine learning is identified.

12. The communication apparatus according to claim 1, further comprising:
a receiver configured to receive, from the other communication apparatus, a model used for the machine learning processing after the message is transmitted.

13. The communication apparatus according to claim 1, wherein
the other communication apparatus is a base station or a core network apparatus, and the communication apparatus is a user equipment.

14. The communication apparatus according to claim 13, wherein
the other communication apparatus is the base station, and the message is an RRC message.

15. The communication apparatus according to claim 13, wherein
the other communication apparatus is the core network apparatus, and the message is a NAS message.

16. The communication apparatus according to claim 1, wherein
the other communication apparatus is a core network apparatus, and the communication apparatus is a base station.

17. The communication apparatus according to claim 1, wherein
the other communication apparatus is a first base station, and the communication apparatus is a second base station.

18. A communication method performed by a communication apparatus configured to communicate with another communication apparatus different from the communication apparatus in a mobile communication system using a machine learning technology, the communication method comprising:
performing machine learning processing of learning processing to derive a learned model by using learning data and/or inference processing to infer inference result data from inference data by using the learned model; and
transmitting, to the other communication apparatus, a message comprising an information element related to a processing capacity and/or a storage capacity usable by the communication apparatus for the machine learning processing.
